(19) United States
(12) Patent Application Publication
(10) Pub. No.: US 2001/0050274 A1
(43) Pub. Date: Dec. 13, 2001

(54) Defogger

(76) Inventor: Andrew M. Decker, Canton, CT (US)

Correspondence Address: Andrew M. Decker, 52 Ridge Road, Canton, CT, 06019, US

(21) Appl. No.: 09/872,991

(22) Filed: Jun. 2, 2001

Related U.S. Application Data
(60) Provisional application No. 60/209,305, filed on Jun. 5, 2000.

(51) Int. Cl. H05B 3/84; F24H 3/04

(52) U.S. Cl. 219/219; 392/379

(57) ABSTRACT

The “Defogger” is a new device developed from several existing components, which will eliminate fog or condensation formed from the floating vapor molecules produced from showers, which collects on the face of a bathroom mirror. This combination of components has not been structured, built, or utilized to perform this function explained in the specification as to my knowledge and through extensive research on the subject matter. The “Defogger” has been devised as a new device, which will eliminate fog or condensation from a mirror, unlike such existing mechanisms, this invention works better and faster than the present standard existing moisture removal systems, or for example, “The Bathroom Ceiling Fan.” The “Defogger” can be utilized in hotels, motels, homes, or any where steam/vapor travel can accumulate onto glass or mirror surfaces.

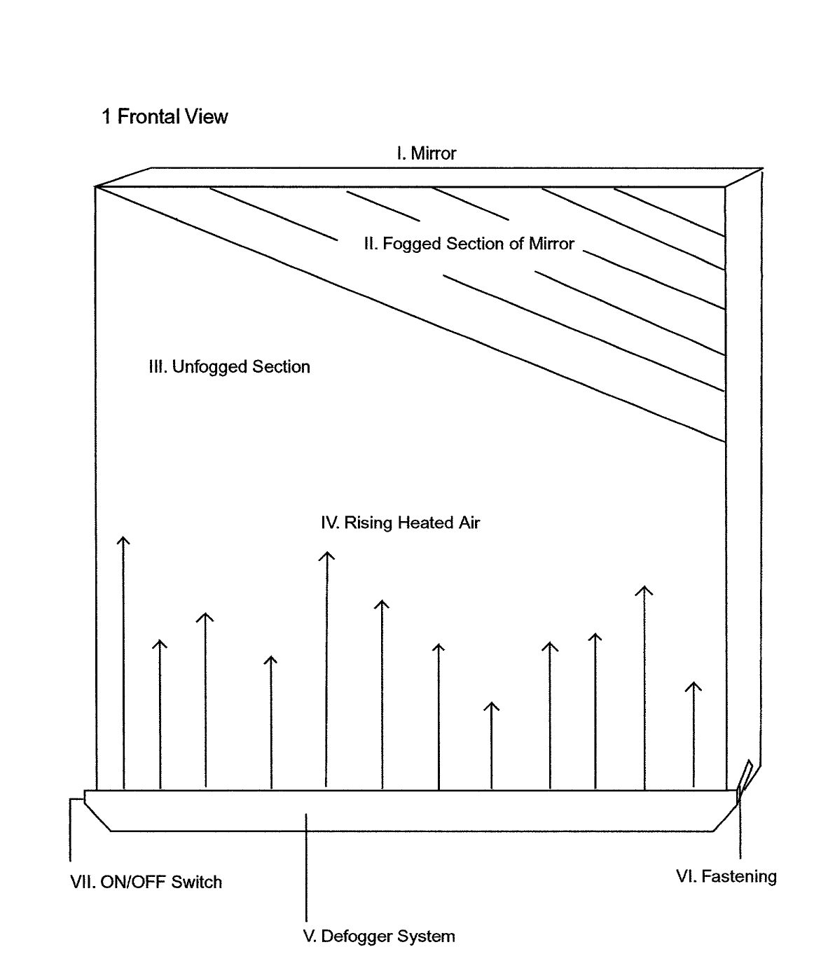

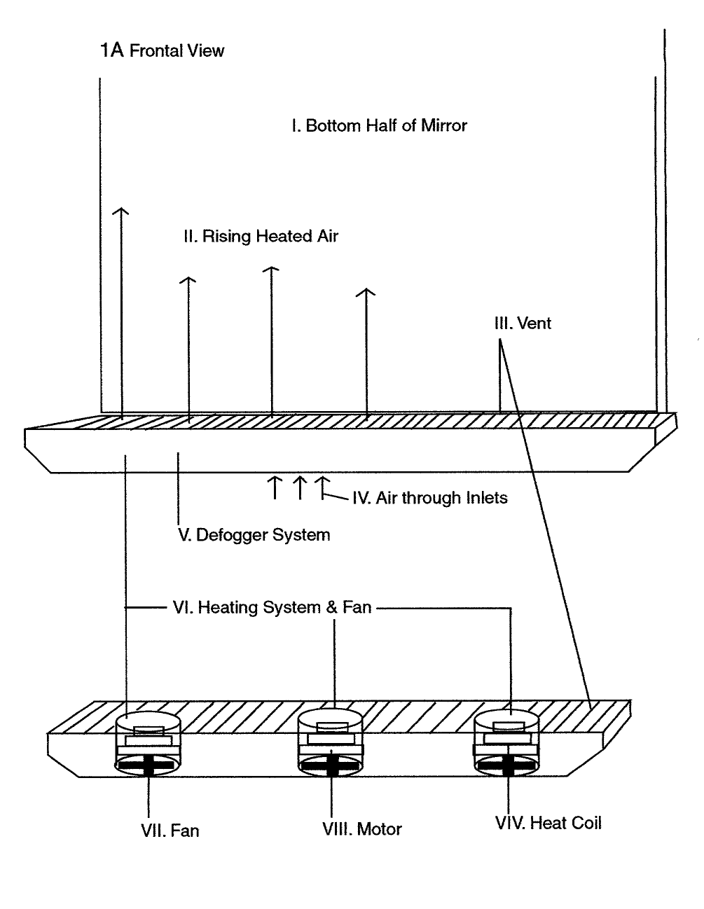

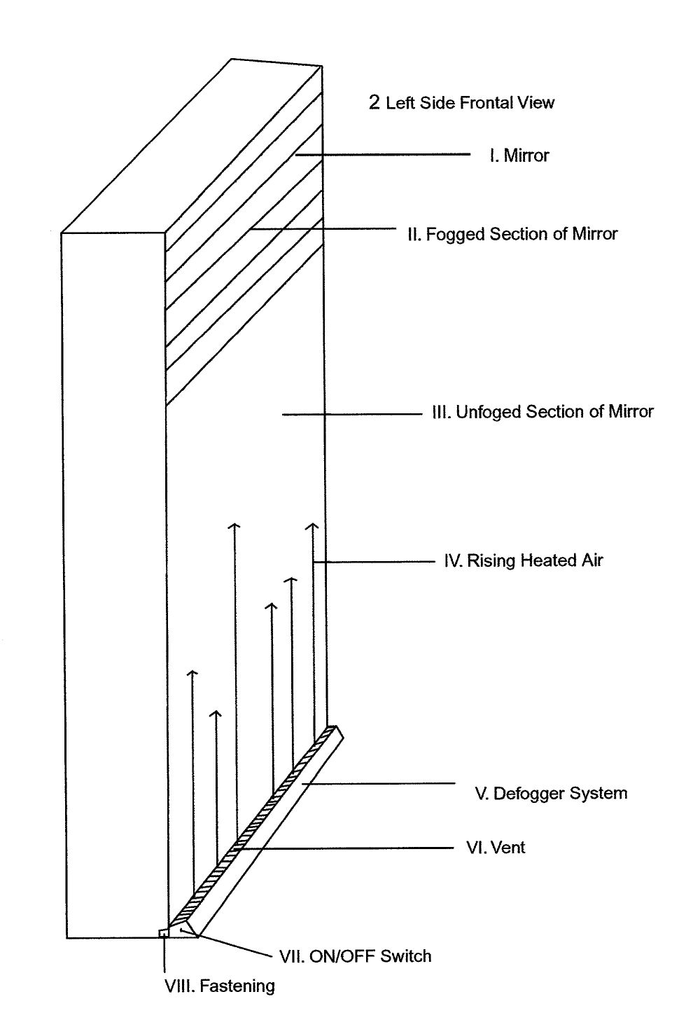

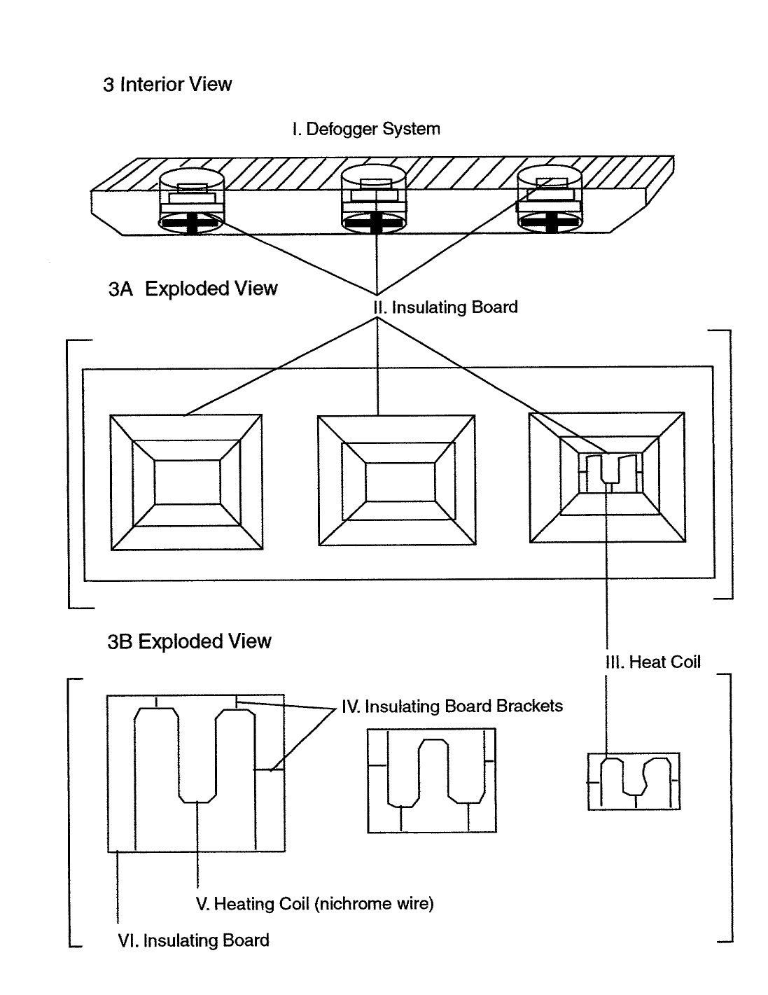

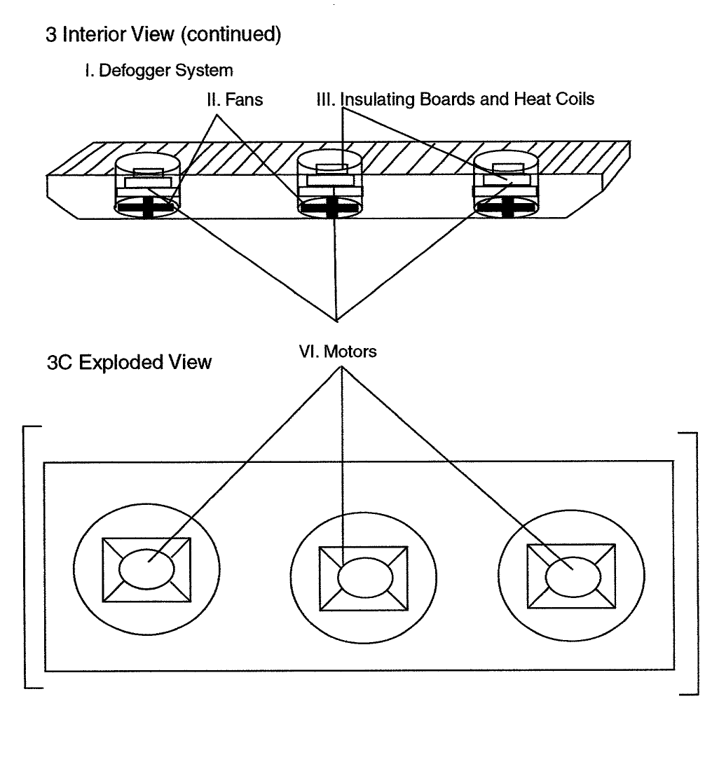

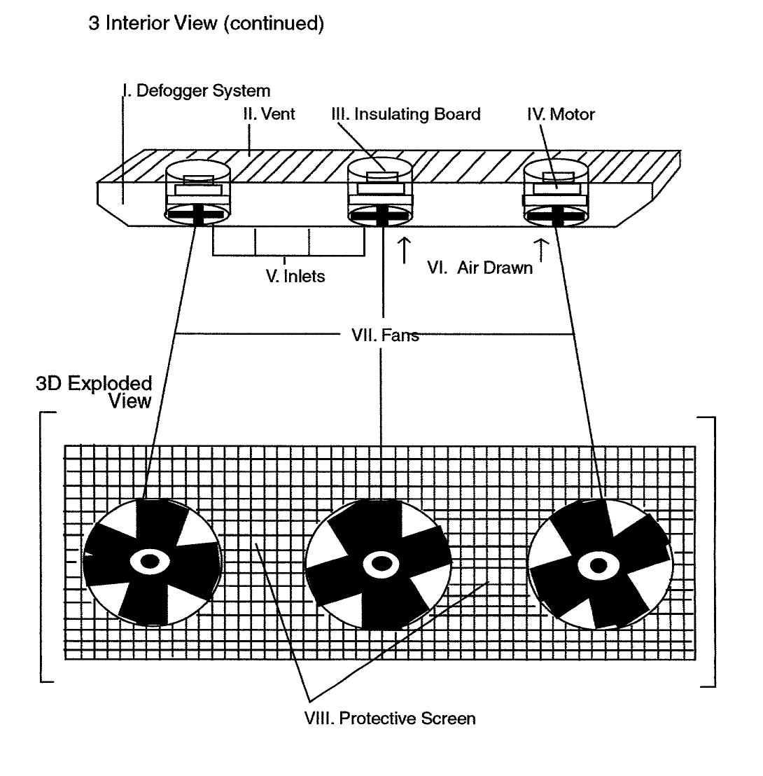

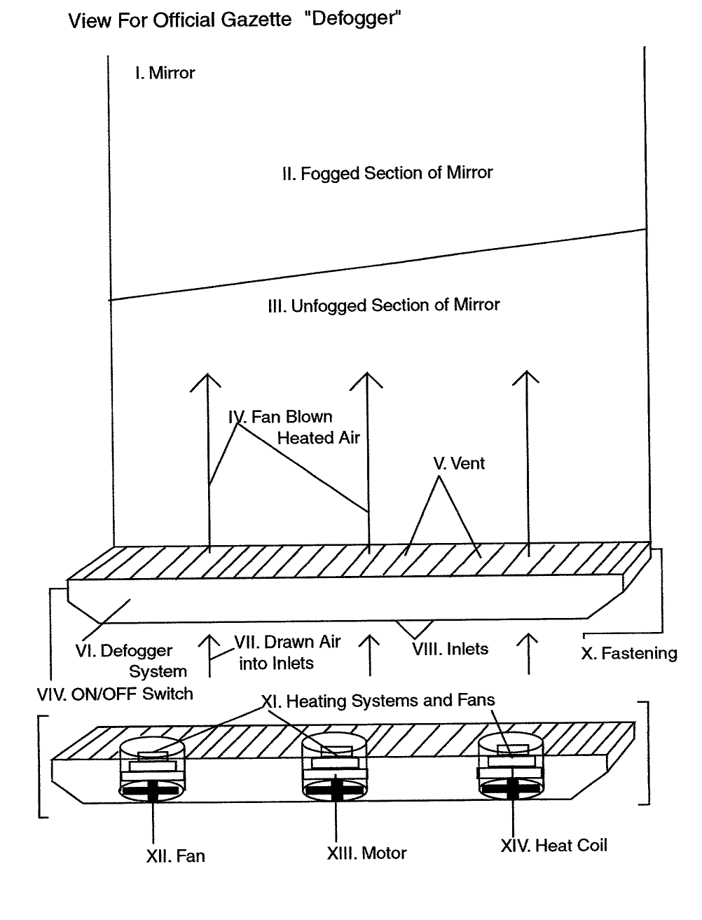

### CROSS-REFERENCE TO RELATED APPLICATIONS

“Not Applicable”

### STATEMENT REGARDING FEDERALLY SPONSERED RESEARCH OR DEVELOPMENT

“Not Applicable”

### REFERENCE TO MICROFICHE APPENDIX

“Not Applicable”

### BACKGROUND OF THE INVENTION

The field of endeavor to which the “Defogger” pertains to is the specified removal of condensation accumulated on bathroom mirrors after one has taken a shower. A specific reference to documents or examples related to this invention known to my knowledge and through thorough research, are the basic air conditioning and heating system components found in an automobile. Basically, the purpose of the “Defogger” is to rid condensation on the surface of bathroom mirrors in a method which is quite similar, however composed differently, to the way heating systems function in defrosting the fogged windshields contrived in vehicles.

When one takes a hot shower, the steam/vapor forms as a result of the super excited water molecules changing from a gas into a liquid. The hot water coming out of the shower is part vapor. That vapor travels through the air and condenses on the walls, floor, windows, and mirrors in the bathroom. Because these surfaces have less energy, they slow the steam/vapor molecules back down to a liquid form, or in other words, condensation. For example, if the surface is super cold, like your windshield in the winter, it slows down the molecules so much, to where they become a solid, ice or frost.

In bathrooms, we have ceiling fans to help suck out the steam/vapor which causes the condensation to form on the mirrors. However, this is a slow process and does not work fast enough for after one gets out of the shower and goes to use the bathroom mirror; it is still necessary to wipe the accumulated fog or condensation for clear visibility of the mirror. In conclusion, the ceiling fans do not fully contribute to the “rapid removal” of the condensation accumulated on bathroom mirrors after one takes a shower.

### BRIEF SUMMARY OF THE INVENTION

In it's simplest form, the general objective of the “Defogger” is to keep the air around the mirror and the mirror itself hot (heated) so that the vapor molecules won't slow down and form a layer of fog on top of the glass (mirror) after one takes a shower. This is done by the use of several components arranged accordingly to produce a projected stream of heated air which gathers around the surface of the mirror allowing visibility to restore. In brief, there are two main contents involved to produce this process of heat projection. The first is motorized fans. Their purpose is to suck in air from the bottom inlets of the “Defogger”, then blow it upward through the “heating system” and through the “Defogger” casing and upper vent, which is directed on to the face of the mirror. And the second is the “heating system”. This consists of bare copper nichrome wire (heat coil), which is wrapped around an insulating board. When the “Defogger” is turned on, the electric current causes the wire (heat coil) to heat up and the fans bring in cool air which is then heated by the wire (heat coil), then blown through the upper vent of the “Defogger” on to the mirror.

Overall, this is a major advantage than just the prior use of a bathroom ceiling fan. The “Defogger” will serve as a faster and more promising device to keep the face of bathroom mirrors clear and visible after one takes a shower rather than just relying on the slow process of the ceiling fan. The ceiling fan's purpose is to suck the steam/vapor out of the room, which in the long run allows the mirror to return to its normal visibility status. However, this is a slow process, and by the time one goes to use the mirror after a shower, the mirror is still full of condensation and visibility is low. However, the “Defogger” works with a more direct contact to the area afflicted by the condensation providing clear visibility on the mirror even if the room is still saturated with the steam/vapor from the shower. The room could be in a state of vaporized steam and the “Defogger” would still be capable of keeping the mirror clear of condensation regardless of the amount of vapor.

### BRIEF DESCRIPTION OF THE SEVERAL VIEWS OF THE DRAWING

1/7 1 Frontal View: I. Mirror, bathroom mirror. II. Fogged Section of Mirror; produced by condensation forming as a result of vapor/steam from shower. III. Unfogged Section of Mirror; due to the contact with the projected heat from the “Defogger's” vent, which clears the mirror surface. IV. Rising Heated Air; blown upward due to the shape of the “Defogger's” vent and the motorized fans, which is heated from the nichrome wire (heat coil). V. Defogger System; basic shape, hard plastic. VI. Fastening; either clamps or bolted (depending on mirror size and shape). VII. ON/OFF Switch; allowing a direct current to power the system.

2/7 1A Frontal View: I. Bottom Half of Mirror. II. Rising Heated Air. III. Vent; heat projected air blown upward through here. IV. Air through Inlets; air sucked into the “Defogger” casing by the fans through inlets along the bottom of the device. V. Defogger System. VI. Heating System & Fan; a makeup of the motorized fans and the bare nichrome wire (heat coil) attached to the insulating board. VII. Fan. VIII. Motor. VIV. Heat Coil; bare nichrome wire.

3/7 2 Left Side Frontal View: I. Mirror. II. Fogged Section of Mirror. HI. Unfogged Section of Mirror. IV. Rising Heated Air. V. Defogger System. VI. Vent. VII. ON/OFF Switch. VIII. Fastening.

4/7 3 Interior View: I. Defogger System. II. Insulating Board; supports the bare nichrome wire or heat coil, which is wrapped around the insulated board.

3A Exploded View: II. Insulating Board; made of mica. III. Heat Coil; bare coiled nichrome wire.

3B Exploded View: III. Heat Coil. IV. Insulating Board Brackets; braces the heat coil to the insulating board. V. Heating Coil; or nichrome wire coil. VI. Insulating Board.

5/7 3 Interior View (continued): I. Defogger System. II. Fans. III. Insulating Boards and Heat Coils. VI. Motors; small motors which fit inside the center of the fan and in between the insulating board.

3C Exploded View: VI. Motors; three of them for this particular design.

6/7 3 Interior View (continued): I. Defogger System. II. Vent. III. Insulating Board. IV. Motor. V. Inlets; allows air to be drawn into the “Defogger” by the fans into the heating system. VI. Air Drawn; through the inlet holes assisted by the fans. VII. Fans.

3D Exploded View: VII. Fans. VIII. Protective Screen; located directly on the bottom in between the inlets and the fan, it prevents small particles of flint from being sucked into the system.

7/7 View for Official Gazette: I. Mirror. II. Fogged Section of Mirror. III. Unfogged Section of Mirror. IV. Fan Blown Heated Air. V. Vent. VI. Defogger System. VII. Drawn Air into Inlets. VIII. Inlets. VIV. ON/OFF Switch. X. Fastening. X. Heating Systems and Fans. XII. Fan. XIII. Motor. XIV. Heat Coil.

### DETAILED DESCRIPTION OF THE INVENTION

The basic exterior body of the “Defogger” consists of a main rectangular shaped hard plastic casing with the following elements inside or connected:

On the left side of the casing, there is an ON/OFF switch consisting of high or low options depending on the amount of airflow needed to defog the mirror (see page 3/7, figure VII of drawings). Directly located on the bottom of the “Defogger”, is a long inlet, which is screen-like, stretching the length of the body, where air is drawn into the hard plastic casing, with the help from the motorized fans, once the mechanism is turned on (see page 6/7, figures V & VI). A protective aluminum screen is placed on the inside of the device between the inlets and the fans. This works to prevent small particles such as lint from being sucked into the fans (see page 6/7, figure VIII).

There are three small motors attached to sit inside the three fans (or motorized fans) of the “Defogger” (see page 5/7, all figures). When the system is plugged in, or hard wired to electric power, and then switched on, current begins to flow through the wiring system of the “Defogger” The bare, coiled wire, or nichrome, becomes hot from the electric energy as the current also gives the motors power to turn the fans. Air is drawn though the small inlets located on the bottom of the system's body thorough the centrifugal movement of the fan blades (see page 6/7, figure V, VI, and VII).

After the air is sucked into the fan, it is then blown upward through the middle casing of the “Defogger” which contains the heating system, consisting of bare, coiled nichrome wire, wrapped around insulated mica boards (see page 4/7, all figures). This is the same wire, (nichrome), an alloy of the two metals chromium and nickel, used in other such heating systems as toasters and curling irons.

The airflow, which is generated by the fans, initially enters the casing at a cooler temperature (2/7, figure IV). The rising heat from the heat coil or nichrome wire, warms the fan forced flowing air. With the help from convection and the force of incoming and outgoing airflow provided by the fan, this cycle thus repeats itself (Pages 2/7, IV & VI, 6/7, all figures.) This heated air is in turn directed in an upward flow (see pages 1/7,IV, 2/7,II-III, and 3/7, W & VI) onto the surface of the fogged (condensated) mirror, where it makes contact with the fog and begins to speed up the vapor molecules around or on the mirror by heating up the surrounding area and surface, thus physically working to rid the fog and clear the condensation on the glass (mirror).

*Note: The size of the “Defogger”, amount of fans, etc., all depends on how large or small the mirror is. Also, different fastenings may be applicable to different types of bathroom mirrors.

1. What I claim as my invention, “Defogger”, is a new mechanism specifically designed for bathroom mirrors constructed from various existing components to create moving convective heat, enabling the fog (steam/vapor), generated from the use of a bathroom shower, and collected as condensation on the face of a bathroom mirror, to be dispersed through the upward convective heat transfer of the “Defogger”, while it also heats the air surrounding the mirror and the mirror itself so that the vapor molecules, produced from the steam of the shower, won't slow down and reform the layer of fog removed from the mirror by the “Defogger”.
